(19) United States
(12) Patent Application Publication
(10) Pub. No.: US 2005/0167413 A1
(43) Pub. Date: Aug. 4, 2005

(54) Cooking heater

(75) Inventor: Yu Jeub Ha, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/940,616

(22) Filed: Sep. 15, 2004

(30) Foreign Application Priority Data
Feb. 2, 2004 (KR) 2004-6721

(51) Int. Cl. A21B 1/00

(52) U.S. Cl. 219/394

(57) ABSTRACT

A cooking heater which efficiently cooks foods of various sizes. The cooking heater includes a main body defining an external appearance of the cooking heater, a plurality of cooking chambers having different volumes, and a plurality of heating devices for separately heating the plurality of cooking chambers. Since the foods of various sizes are selectively contained in one of the plurality of cooking chambers, the cooking heater efficiently heats the foods based on the sizes of the foods.

### CROSS-REFERENCE TO RELATED APPLICATIONS

This application claims the benefit of Korean Patent Application No. 2004-6721 filed on Feb. 2, 2004, in the Korean Intellectual Property Office, the disclosure of which is incorporated herein by reference.

### BACKGROUND OF THE INVENTION

1. Field of the Invention

The present invention relates to a cooking heater, and more particularly, to a heater which efficiently cooks foods of various sizes.

2. Description of the Related Art

Generally, cooking heaters heat foods contained in a cooking chamber disposed therein such as microwave ovens, electric oven ranges, and gas oven ranges.

A conventional cooking heater includes a main body defining an external appearance having a cooking chamber for containing foods to be cooked therein, and a heating device, such as a heater, for heating the foods contained in the cooking chamber.

The conventional cooking heater includes a large volume so that the cooking chamber is able to hold foods of various sizes. Accordingly, since the entire interior of the cooking chamber is heated to cook the foods when the foods are cooked by the conventional cooking heater, heat loss occurs when the food being heated is of a small size.

### SUMMARY OF THE INVENTION

Accordingly, it is an aspect of the present invention to provide a cooking heater to efficiently heat foods of various sizes.

Additional aspects and/or advantages of the invention will be set forth in part in the description which follows and, in part, will be obvious from the description, or may be learned by practice of the invention.

The foregoing and/or other aspects of the present invention are achieved by providing a cooking heater comprising a main body defining an external appearance of the cooking heater, a plurality of cooking chambers having different volumes and a plurality of heating devices to separately heat the plurality of cooking chambers.

The plurality of cooking chambers comprise a main cooking chamber having a designated volume, and a subsidiary cooking chamber having a volume smaller than the designated volume of the main cooking chamber.

The main cooking chamber and the subsidiary cooking chamber respectively comprise front surfaces opened to contain foods and to take the foods out of each of the main and subsidiary cooking chambers, and a main door and a subsidiary door to open and close the main cooking chamber and the subsidiary cooking chamber are attached to the front surfaces of the main cooking chamber and the subsidiary cooking chamber, respectively.

The subsidiary cooking chamber and an electric component chamber having various electric components to control the operation of the cooking heater are divisionally disposed above the main cooking chamber in the main body.

The heating devices comprise a fan disposed at the rear part of the main cooking chamber to generate an air-blowing force, and a main heater having a ring shape disposed at the outer circumference of the fan to emit heat and heating air discharged from the fan.

The heating devices further comprise subsidiary heaters respectively disposed at upper and lower parts of the subsidiary cooking chamber to emit heat and heating foods disposed therebetween.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a perspective view of a cooking heater in accordance an embodiment of the invention; and

FIG. 2 is a longitudinal-sectional view of the cooking heater as shown in FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

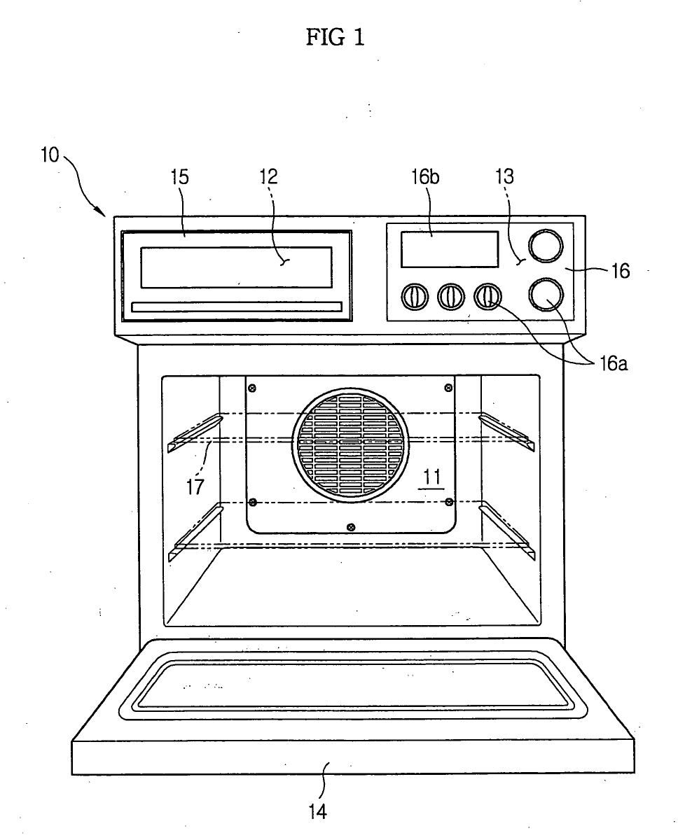

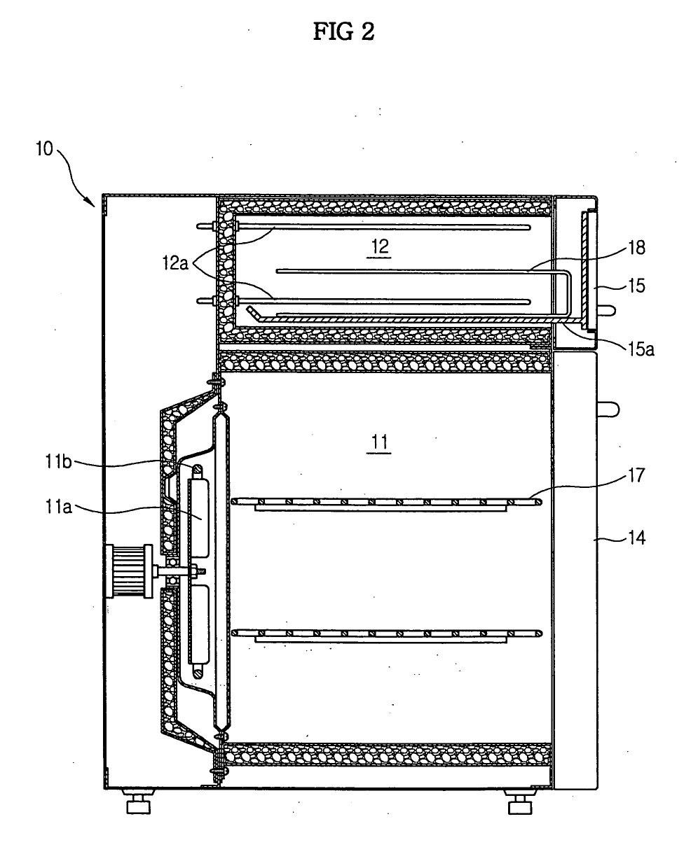

In FIGS. 1 and 2, a cooking heater in accordance with the present invention comprises a main body 10 defining an external appearance, a pair of cooking chambers 11 and 12 having different volumes disposed in the main body 10, and an electric component chamber 13 having various electric components to control the operation of the cooking heater.

The cooking chambers 11 and 12 comprise a main cooking chamber 11 having a designated volume to contain and cook a plurality of foods of various sizes, and a subsidiary cooking chamber 12 having a volume smaller than the designated volume of the main cooking chamber 11 to contain and cook only smaller-sized foods. The main cooking chamber 11 and the subsidiary cooking chamber 12 respectively comprise front surfaces opened to contain foods and take the foods out of each of the main and subsidiary cooking chambers 11 and 12To efficiently use the inside of the main body 10, the subsidiary cooking chamber 12 and the electric component chamber 13 are disposed in parallel above the main cooking chamber 11.

When food of a large size is cooked by the cooking heater, the food is put into the main cooking chamber 11, and when a food of a small size is cooked by the cooking heater, the food is put into the subsidiary cooking chamber 12. Thereby, the cooking heater of the present invention effectively cooks foods based on the size of the food, thus greatly reducing heat loss generated when a food of a small size is cooked in a cooking chamber having a large volume as in the conventional cooking heater.

A main door 14 and a subsidiary door 15 to open and close the opened front surfaces of the main cooking chamber 11 and the subsidiary cooking chamber 12 are attached to a front surface of the main body 10. A control panel 16 having various operational buttons 16a to control the operation of the cooking heater and a display unit 16b to display the operational state of the cooking heater, is disposed on the front surface of the electric component chamber 13.

In this embodiment of the present invention, a lower end of the main door 14 is hinged to a lower part of the main body 10 so that an upper end of the main door 14 is rotated to open and close the main cooking chamber 11, and the subsidiary door 15 moves forward and backward to open and close the subsidiary cooking chamber 12. The subsidiary door 15 comprises a receipt portion 15a, on which foods are mounted, extended toward a rear part of the subsidiary cooking chamber 12, thereby allowing the foods to be put into or taken out of the subsidiary cooking chamber 12 according to the forward and backward movement of the subsidiary door 15. Grilling members 17 and 18 are disposed in the main cooking chamber 11 and the subsidiary cooking chamber 12, respectively, to allow the foods to be cooked under the condition that the foods are disposed at central portions in the main cooking chamber 11 and the subsidiary cooking chamber 12.

Further, heating devices to heat the foods are respectively disposed in the main cooking chamber 11 and the subsidiary cooking chamber 12. In this embodiment of the present invention, the heating devices comprise a fan 11 a disposed at the rear part of the main cooking chamber 11 to generate an air-blowing force, a main heater 11b having a ring shape disposed at an outer circumference of the fan 11a to heat air discharged by the fan 11a and to increase the temperature in the main cooking chamber 11, and subsidiary heaters 12a respectively disposed at upper and lower parts of the subsidiary cooking chamber 12 to apply heat directly to foods mounted on the grilling member 17. Each of the main heater 11b and the subsidiary heater 12a comprises an electric heating wire to generate heat by power supplied thereto.

Accordingly, power is supplied to one or both of the main fan 11a and the main heater 11b, disposed in the main cooking chamber 11, and the subsidiary heater 12a disposed in the subsidiary cooking chamber 12, to separately heat the main cooking chamber 11 and the subsidiary cooking chamber 12.

In this embodiment of the present invention, the cooking heater comprises a pair of the main cooking chamber 11 and the subsidiary cooking chamber 12. However, the cooking heater may comprise more than two cooking chambers having different volumes.

As apparent from the above description, the present invention provides a cooking heater comprising a plurality of cooking chambers having different volumes so that foods of various sizes are selectively contained by one of the plurality of cooking chambers, thereby efficiently heating the foods based on the sizes of the foods.

Although a few embodiments of the present invention have been shown and described, it would be appreciated by those skilled in the art that changes may be made in this embodiment without departing from the principles and spirit of the invention, the scope of which is defined in the claims and their equivalents.

1. A cooking heater comprising:
a main body defining an external appearance of the cooking heater;
a plurality of cooking chambers having different volumes; and
a plurality of heating devices to separately heat the plurality of cooking chambers.

2. The cooking heater of claim 1, wherein the plurality of cooking chambers comprise a main cooking chamber having a designated volume, and a subsidiary cooking chamber having a volume smaller than the designated volume of the main cooking chamber.

3. The cooking heater of claim 2, wherein the main cooking chamber and the subsidiary cooking chamber respectively comprise:
front surfaces opened to contain foods and to take the foods out of each of the main and subsidiary cooking chambers; and
a main door and a subsidiary door to open and close the main cooking chamber and the subsidiary cooking chamber, are attached to the front surfaces of the main cooking chamber and the subsidiary cooking chamber, respectively.

4. The cooking heater of claim 2, wherein the subsidiary cooking chamber, and an electric component chamber having various electric components to control the operation of the cooking heater, are divisionally disposed above the main cooking chamber in the main body.

5. The cooking heater of claim 2, wherein the heating devices comprise:
a fan disposed at the rear part of the main cooking chamber to generate an air-blowing force; and
a main heater having a ring shape disposed at an outer circumference of the fan to emit heat and heating air discharged from the fan.

6. The cooking heater of claim 2, wherein the heating devices further comprise subsidiary heaters disposed at upper and lower parts of the subsidiary cooking chamber, respectively, to emit heat and heating foods disposed therebetween.

7. The cooking heater of claim 4, wherein the subsidiary cooking chamber and the electric component chamber are disposed in parallel above the main cooking chamber.

8. The cooking heater of claim 3, wherein the main door is hinged to a lower part of the main body so that an upper end of the main door rotates to open and close the main cooking chamber, and the subsidiary door moves forward and backward to open and close the subsidiary cooking chamber.

9. The cooking heater of claim 3, wherein the subsidiary door comprises a receipt portion on which foods are mounted and which extends toward a rear part of the subsidiary cooking chamber, to allow the foods to be put into and taken out of the subsidiary cooking chamber in accordance with the forward and backward movement of the subsidiary door.
